(19) United States
(12) Patent Application Publication
(10) Pub. No.: US 2011/0129773 A1
(43) Pub. Date: Jun. 2, 2011

(54) TONER, DEVELOPER, DEVELOPER CONTAINER, METHOD OF MANUFACTURING TONER, AND IMAGE FORMING METHOD

(76) Inventors: Hyo SHU, Kanagawa (JP); Fumihiro Sasaki, Shizuoka (JP); Hiroshi Yamashita, Shizuoka (JP); Masaki Watanabe, Shizuoka (JP); Junichi Awamura, Shizuoka (JP); Tsuyoshi Sugimoto, Shizuoka (JP); Teruki Kusahara, Shizuoka (JP); Satoshi Ogawa, Nara (JP); Ryota Inoue, Osaka (JP); Daisuke Inoue, Shizuoka (JP)

(21) Appl. No.: 12/938,789

(22) Filed: Nov. 3, 2010

(30) Foreign Application Priority Data
Nov. 30, 2009 (JP) 2009-271523

(51) Int. Cl. G03G 9/08; G03G 9/087; G03G 13/20

(52) U.S. Cl. 430/108.8; 430/137.14; 430/124.1

(57) ABSTRACT

A toner including a binder resin comprising a modified polyester having an ester bond and a chemical bond other than the ester bond, and a crystalline polyester; and a release agent comprising a microcrystalline wax comprising a hydrocarbon having 20 to 80 carbon atoms which comprises 55 to 70% by weight of a linear hydrocarbon. The microcrystalline wax has an acid value of from 0.1 to 20 mgKOH/g and a melting point of from 65 to 90° C. The melting point is a temperature at which a local maximum endothermic peak is observed in a differential thermal curve measured by differential scanning calorimetry (DSC). The release agent is dispersed in the toner with a dispersion diameter of from 0.06 to 1.50 μm.

### CROSS-REFERENCE TO RELATED APPLICATIONS

The present patent application claims priority pursuant to 35 U.S.C. §119 from Japanese Patent Application No. 2009-271523, filed on Nov. 30, 2009, which is hereby incorporated by reference herein in its entirety.

### BACKGROUND

1. Field of the Invention

The present invention relates to a toner for developing electrostatic latent images into visible images in electrophotography or electrostatic recording. In addition, the present invention also relates to a developer containing the toner, a developer container containing the developer, a method of manufacturing the toner, and an image forming method using the toner.

2. Description of the Background

In electrophotography, electrostatic recording, and electrostatic printing, a developer is adhered to an electrostatic latent image formed on an image bearing member (e.g., a photoreceptor), then transferred from the image bearing member onto a transfer material (e.g., paper), and finally fixed thereon. Developers that develop electrostatic latent images into visible images are broadly classified into two-component developers comprised of a toner and a carrier, and one-component developers comprised of a toner and no carrier.

Toners used for electrophotography, electrostatic recording, and electrostatic printing are generally manufactured by kneading binder resins (e.g., styrene resins, polyester resins) and colorants upon application of heat, and pulverizing the kneaded mixture into fine particles. Such a process is called pulverization.

Recently, toners are required to be much smaller and more spherical particles to meet increasing demand for much higher quality images. However, toner particles manufactured through the pulverization process generally have an irregular shape. Such toner particles are likely to be further pulverized into undesired ultrafine particles when agitated with carrier particles in a developing device, when used for a two-component developer, or contacted with a developing roller, a toner supply roller, a toner regulator, or a frictional charging blade, when used for a one-component developer. Although such toner particles having an irregular shape need a large amount of a fluidizer due to their poor fluidity, the fluidizer present on the surfaces of the toner particles is likely to be buried therein. For the above reasons, toner particles having an irregular shape cannot meet the demand for higher quality images.

Additionally, toner particles having an irregular shape pack poorly and thus fill a toner bottle at a low filling rate, thus preventing downsizing of the toner bottle. Moreover, such toner particles having an irregular shape cannot effectively be transferred from an image bearing member onto a transfer material, thus producing defective images while consuming a large amount of toner particles in the process.

Therefore, toner particles are required to be much more effectively transferred from an image bearing member onto a transfer material to reduce toner consumption and prevent production of defective images. When toner particles can be transferred from an image bearing member onto a transfer material with a high efficiency, there is no need to provide a cleaner for removing residual toner particles from the image bearing member after image transfer, resulting in downsizing of image forming apparatus, cost reduction, and waste toner reduction. In view of this situation, various processes for manufacturing spherical toner particles have been proposed.

On the other hand, spherical toner particles are disadvantageous in that the surfaces thereof are exposed to direct contact with carrier particles or a charging blade, which results in contamination and deterioration of the carrier particles or the charging blade. Additionally, spherical toner particles may scatter to contaminate background portions of the resulting images.

In attempting to solve the above-described problems of spherical toner particles, Japanese Patent Application Publication No. 07-152202 (JP-H07-152202-A) proposes a method of manufacturing toner including steps of dispersing or dissolving toner components in a volatile solvent (e.g., a low-boiling-point organic solvent), emulsifying the resultant toner components liquid in an aqueous medium in the presence of a disperser to form liquid droplets, and removing the volatile solvent from the liquid droplets. This method is one of several polymer dissolution suspension methods in which the liquid droplets contract to reduce their volume at the time the volatile solvent is removed from the liquid droplets. Therefore, in a case in which the disperser is a particulate solid disperser insoluble in the aqueous medium, the resulting toner particles must have an irregular shape. Alternatively, in a case in which the amount of the toner components is relatively large compared to that of the volatile solvent, for the purpose of increasing toner productivity, the resultant emulsion may have a large viscosity. In this case, the resulting toner particles have a large size and a wide size distribution.

Japanese Patent No. 4284005 discloses a method of manufacturing toner including steps of dissolving or dispersing toner components in an organic solvent and emulsifying the resultant toner components liquid in an aqueous medium to aggregate the toner components. The patent also discloses another similar method including steps of kneading toner components upon application of heat, dissolving or dispersing the kneaded toner components in an organic solvent, emulsifying the resultant toner components liquid in an aqueous medium, and removing the organic solvent. Toners manufactured through these methods have a variety of good properties. For example, such toners prevent phase separation of binder resins, and improve dispersibility of toner components by preventing localization or aggregation thereof, thus providing good chargeability and releasability. However, such toners still contaminate carrier particles or charging members.

JP-H11-149179-A discloses a method of manufacturing toner including steps of reacting a prepolymer having an active hydrogen group with a compound having two or more functional groups reactive with the active hydrogen group in an aqueous medium. This method is one of several improved polymer dissolution suspension methods in which a low-molecular-weight binder resin precursor (i.e., the prepolymer) is used to reduce viscosity of the emulsion or improve fixability of the resulting toner. However, the toner manufactured through this process still contaminates carrier particles or charging members.

### SUMMARY

Exemplary aspects of the present invention are put forward in view of the above-described circumstances, and provide a novel toner that does not contaminate carrier particles or charging members even when the toner shape is spherical.

In one exemplary embodiment, a novel toner includes a binder resin comprising a modified polyester having an ester bond and a chemical bond other than the ester bond, and a crystalline polyester; and a release agent comprising a microcrystalline wax comprising a hydrocarbon having 20 to 80 carbon atoms which comprises 55 to 70% by weight of a linear hydrocarbon. The microcrystalline wax has an acid value of from 0.1 to 20 mgKOH/g and a melting point of from 65 to 90° C. The melting point is a temperature at which a local maximum endothermic peak is observed in a differential thermal curve measured by differential scanning calorimetry (DSC). The release agent is dispersed in the toner with a dispersion diameter of from 0.06 to 1.50 μm.

Other exemplary aspects of the present invention are put forward in view of the above-described circumstances, and provide a novel method of manufacturing the above toner.

In one exemplary embodiment, a novel method of manufacturing the toner includes dissolving or dispersing toner components including a release agent and one or both of a binder resin and a precursor thereof in an organic solvent to prepare a toner components liquid; emulsifying the toner components liquid in an aqueous medium to prepare an emulsion; and removing the organic solvent from the emulsion.

Yet other exemplary aspects of the present invention are put forward in view of the above-described circumstances, and provide a novel image forming method using the above toner.

In one exemplary embodiment, a novel image forming method includes charging an image bearing member; developing an electrostatic latent image formed on the charged image bearing member into a toner image with the above toner; transferring the toner image from the image bearing member onto a transfer member; and fixing the toner image on the transfer member by applying heat and pressure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross-sectional image of the toner according to this specification obtained with a transmission electron microscope; and

FIG. 2 schematically illustrates an image forming apparatus for practicing the image forming method according to this specification.

### DETAILED DESCRIPTION

The toner according to this specification comprises a binder resin comprising a modified polyester having an ester bond and a chemical bond other than the ester bond and a crystalline polyester, and a release agent comprising a microcrystalline wax. The release agent is dispersed in the toner with a dispersion diameter of from 0.06 to 1.50 μm. The microcrystalline wax comprises a hydrocarbon having 20 to 80 carbon atoms, and the hydrocarbon comprises 55 to 70% by weight of a linear hydrocarbon. The microcrystalline wax has an acid value of from 0.1 to 20 mgKOH/g and a melting point of from 65 to 90° C. The melting point is defined as a temperature at which a local maximum endothermic peak is observed in a differential thermal curve measured by differential scanning calorimetry (DSC).

The above-described toner can be prepared by dissolving or dispersing toner components including the binder resin and/or a precursor thereof and the release agent in an organic solvent to prepare a toner components liquid, emulsifying the toner components liquid in an aqueous medium, and removing the organic solvent from the resulting emulsion.

The crystalline polyester improves fixability of the toner, and also helps the microcrystalline wax to be finely dispersed in the toner. Thus, the microcrystalline wax is prevented from contaminating carrier particles or charging members. When the microcrystalline wax comprises a hydrocarbon having 20 to 80 carbon atoms and the hydrocarbon comprises 55 to 70% by weight of a linear hydrocarbon, such a microcrystalline wax can be more finely dispersed in the toner.

Accordingly, when the crystalline polyester and the microcrystalline wax comprising a hydrocarbon having 20 to 80 carbon atoms comprising 55 to 70% by weight of a linear hydrocarbon are used in combination, it is likely that the microcrystalline wax is finely dispersed inside the toner and is not exposed at the surface of the toner. Such a toner does not contaminate carrier particles or charging members with the microcrystalline wax, while maintaining good releasability when fixed on a transfer material.

Both the crystalline polyester and the microcrystalline wax are in a crystalline state and do not compatible with other amorphous resins present in the toner, if any. On the other hand, the crystalline polyester and the microcrystalline wax are compatible with each other. Therefore, the crystalline polyester helps the microcrystalline wax to be finely dispersed in the toner, and vice versa.

As described above, the microcrystalline wax comprises a hydrocarbon having 20 to 80 carbon atoms. Preferably, the average number of carbon atoms is 50±20. The smaller the average number of carbon atoms, the better the releasability of the toner at low temperatures. The greater the average number of carbon atoms, the better the resistance of the toner to aggregation and filming. When the average number of carbon atoms is too small, penetration of the toner may be too large, and therefore the toner may aggregate and form films on photoreceptors or fixing members. When the average number of carbon atoms is too large, such a microcrystalline wax cannot be finely dispersed in the toner and cannot be prevented from contaminating carrier particles or charging members.

The number of carbon atoms and the average number of carbon atoms in the release agent can be measured by high-temperature gel permeation chromatography (hereinafter “high-temperature GPC”).

A chromatogram obtained by high-temperature GPC indicates a molecular weight distribution of a sample (e.g., a release agent). By dividing the molecular weight at which the chromatogram starts flowing by 14, which is the molecular weight of methylene group, the minimum number of carbon atoms in the sample is determined. Similarly, by dividing the molecular weight at which the chromatogram terminates flowing by 14, which is the molecular weight of methylene group, the maximum number of carbon atoms in the sample is determined.

The average number of carbon atoms in the sample is determined by dividing the molecular weight at which a peak is observed in the chromatogram by 14, which is the molecular weight of methylene group.

In the above high-temperature GPC measurement, the solvent in use is o-dichlorobenzene including 0.1% of ionol, the temperature is set to 135° C., and the detector in use is a differential refractive index detector. A molecular weight of the sample is determined based on a universal calibration method by converting the absolute molecular weight of polystyrene.

As described above, the hydrocarbon comprises a linear hydrocarbon in an amount of from 55 to 70% by weight, more preferably from 60 to 70% by weight. When the amount of linear hydrocarbon is too large, the hydrocarbon may have too low a melting point and too large a penetration. When the amount of linear hydrocarbon is too small, the hydrocarbon cannot be finely dispersed in the toner.

The amount of linear hydrocarbon in the hydrocarbon can be measured by gas chromatography. Linear hydrocarbons and non-linear hydrocarbons can be separated by their difference in the degree of adsorption or distribution to a stationary phase in gas chromatography. In other words, they can be separated by their difference in migration speed within the stationary phase in gas chromatography. The content of linear hydrocarbon is determined from the retention time and the area of a peak observed in the resulting chromatogram.

The gas chromatography uses a separation column, such as a filling column or a capillary column. The filling column may be filled with adsorptive fillers such as active carbon, active alumina, silica gel, porous spherical silica, molecular sieves, or inorganic salts; or fine particles of diatom earth, refractory brick powder, glass beads, molten silica beads, or graphite, the surfaces of which are coated with an oil such as a paraffin oil and a silicone oil. The capillary column includes no filler, while an oil such as a paraffin oil and a silicone oil is applied thereto. The carrier gas may be nitrogen gas, helium gas, hydrogen gas, or argon gas.

The detector for the gas chromatography may be a heat-ray thermal conductivity meter, a gas densitometer, an ionization cross-sectional area meter, a hydrogen flame ionization detector, a beta ray ionization detector, an electron capture ionization detector, or a radio frequency wave ionization detector.

The hydrocarbon can be obtained by, for example, separation and refinement of a vacuum residue fraction or a distillate of a petroleum oil, and further extraction by high-temperature GPC.

The release agent (including the microcrystalline wax) has an acid value of from 0.1 to 20 mgKOH/g, and more preferably from 3 to 15 mgKOH/g, from the viewpoint of dispersibility thereof in the toner and hot offset resistance of the toner. A release agent having too small an acid value cannot be finely dispersed in the toner, and therefore the toner may contaminate carrier particles or charging members with the release agents. A release agent having too large an acid value is likely to migrate to the aqueous medium at the time the toner components liquid including the release agent is emulsifying in the aqueous medium, and therefore the resulting toner may include an insufficient amount of release agent. Such a toner has poor hot offset resistance. Further, the release agent having too large an acid value is likely to locally present at the surface of the toner. Such a toner is likely to fixedly adhere to a developing device and degrades the resultant image quality. Moreover, because the release agent having too large an acid value is difficult to separate from polyester, the resulting toner may have poor hot offset resistance.

The acid value can be measured by an automatic potentiometric titrator DL-53 TITRATOR (from Mettler-Toledo International Inc.) and an analysis software program LabX Light Version 1.00.000. The titrator is calibrated using a mixed solvent of 120 ml of toluene and 30 ml of ethanol. The measurement temperature is 23° C. and the detailed measurement conditions are as follows.

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

Titrant addition Dynamic

| | |
|---|---|
| dE (set) [mV] | 8.0 |
| dV (min) [mL] | 0.03 |
| dV (max) [mL] | 0.5 |

Measure mode Equilibrium controlled

| | |
|---|---|
| dE [mV] | 0.5 |
| dt [s] | 1.0 |
| t (min) [s] | 2.0 |
| t (max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |

n = 1

| | |
|---|---|
| comb. termination condition | No |

Evaluation

| | |
|---|---|
| Procedure | Standard |
| Potential 1 | No |
| Potential 2 | No |
| Stop for reevaluation | No |

Specifically, the acid value is measured based on a method according to JIS K0070-1992. First, 0.5 g of a sample is added to 120 ml of toluene, and the resulting mixture is agitated for about 10 hours at room temperature (23° C.) so that the sample is dissolved in the toluene. Next, 30 ml of the resulting ethanol solution is titrated with a 0.1 N alcohol solution of potassium hydroxide, and the acid value (AV) is determined from the following equation:

AV (mgKOH/g)=X×N×56.1/W

wherein X represents a titer (ml), N represents the factor of the 0.1 N alcohol solution of potassium hydroxide, and W represents the weight of the sample.

The release agent (including the microcrystalline wax) has a melting point of from 65 to 90° C. In this specification, the melting point is defined as a temperature at which a maximum endothermic peak is observed in a differential thermal curve obtained by differential scanning calorimetry (DSC). When the melting point is too low, the toner may have poor heat resistance storage stability which causes blocking. When the melting point is too high, low temperature fixability of the toner may be poor.

The release agent is finely dispersed in the toner with a dispersion diameter of from 0.06 to 1.50 μm, preferably from 0.1 to 0.3 μm, without localizing at the surface of the toner. In this specification, the dispersion diameter is defined as the maximum diameter.

When the dispersion diameter is too large, each toner particle may include a different amount of release agent. Such a toner has poor chargeability and fluidity. Also, such a toner is likely to fixedly adhere to a developing device, degrading the resultant image quality. When the dispersion diameter is too small, most of the release agent may be present inside the toner, i.e., the relative amount of the release agent at the surface of the toner may be small. Such a toner has poor releasability.

The dispersion diameter of the release agent can be measured by a method described below, for example.

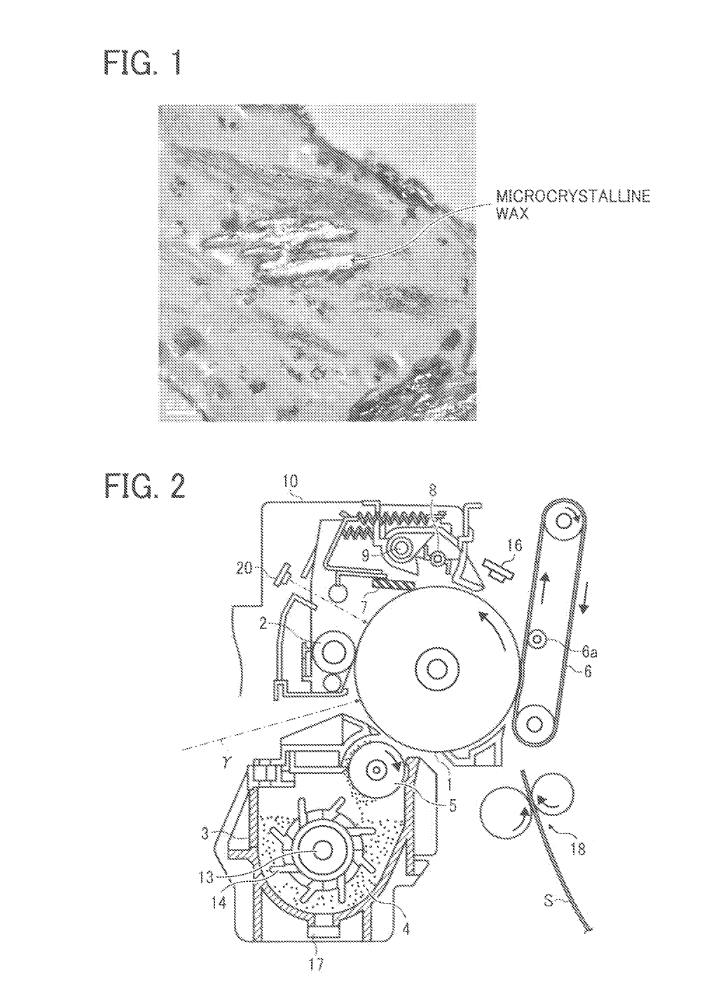

The toner is embedded in an epoxy resin, and then cut into an ultrathin section having a thickness of about 100 nm. After being dyed with ruthenium tetraoxide, the ultrathin section is observed and photographed using a transmission electron microscope (TEM) at a magnification of 10,000 times. FIG. 1 is a cross-sectional image of the toner obtained using TEM. Even in a case in which the dispersed release agent has a needle-like shape, the maximum diameter can be considered as the dispersion diameter.

In a case in which the toner has a specific shape and a specific shape distribution, for example, the average circularity of the toner is less than 0.95, which means that most of the toner particles have an irregular shape far from a sphere, the toner may not effectively transferred from a photoreceptor onto a transfer material and may cause toner scattering.

The shape of toner particles can be determined by passing a suspension containing toner particles on a platy imaging detector in which a CCD camera optically detects and analyzes images of the toner particles.

As a result of such a detection procedure, projected images of the toner particles are obtained. The circularity of each toner particle is determined by the following equation:

Circularity=Cs/Cp

wherein Cp represents the circumferential length of a projected image of a toner particle and Cs represents the circumferential length of a circle having the same area as the projected image of the toner particle. When the average circularity of the toner is from 0.95 to 0.99, high-definition and high-density images are reliably produced with high reproducibility. More preferably, the toner has an average circularity of from 0.96 to 0.99, and includes toner particles having a circularity less than 0.96 in an amount of 10% by number or less.

When the average circularity is too large, such a toner is difficult to remove from a photoreceptor or a transfer belt with a blade member, contaminating the resultant image. Specifically, in a case in which a photographic image having a high image area rate is developed on or transferred from a photoreceptor, or a toner image is not completely transferred from a photoreceptor onto a transfer material due to paper jam, toner particles may be accumulated on the photoreceptor and contaminate the resultant image. Further, such a toner having a large average circularity may contaminate a charging member which contact-charges a photoreceptor, thereby reducing charging ability of the photoreceptor.

The average circularity of the toner can be measured using a flow particle image analyzer FPIA-2000 (from Sysmex Corporation) as follows.

First, a 0.1 to 0.5 ml of a surfactant (preferably alkylbenzene sulfonate) is included as a dispersant in 100 to 150 ml of water from which solid impurities have been removed, and 0.1 to 0.5 g of a toner is added thereto. The resulting suspension is subjected to a dispersion treatment using an ultrasonic disperser for about 1 to 3 minutes. The suspension is adjusted so as to include 3,000 to 10,000 toner particles per 1 micro-liter. The circularity distribution and the average circularity of the toner are determined by the above flow particle image analyzer.

The toner preferably has a volume average particle diameter (Dv) of not less than 3.0 μm and less than 6.0 μm. Further, the ratio (Dv/Dn) of the volume average particle diameter (Dv) to the number average particle diameter (Dn) is preferably from 1.05 to 1.25, more preferably from 1.05 to 1.20.

The above-described toner does not contaminate charging members (e.g., carrier particles, charging blades) and prevents deterioration of chargeability and the occurrence of toner scattering. The toner also has good heat-resistant storage stability, low-temperature fixability, and hot offset resistance. The toner appropriately provides glossy images when used in a full-color image forming apparatus. The toner also provides reliable images for an extended period of time when used in a two-component developer, because the average particle diameter of toner particles in the two-component developer does not vary along with repeated consumption and supplement of toner particles.

Additionally, the toner also provides reliable images for an extended period of time when used in a one-component developer, because the average particle diameter of toner particles in the one-component developer does not vary along with repeated consumption and supplement of toner particles, and the toner does not contaminate image forming members (e.g., a developing roller, a toner regulating blade).

Generally, as the particle diameter of toner becomes smaller, the resolution and quality of the resulting image become better, but the transferability and cleanability of the toner become worse. When a toner having a volume average particle diameter (Dv) smaller than the above-described appropriate range (i.e., not less than 3.0 μm and less than 6.0 μm) is used for a two-component developer, toner particles may adhere to the surfaces of carrier particles when agitated in a developing device, resulting in deterioration of charging ability of the carrier particles. When such a toner is used for a one-component developer, toner particles may form a film on a developing roller or adhere to a toner regulator. A toner including too large an amount of ultrafine particles may also cause the similar phenomena.

A toner having a volume average particle diameter (Dv) greater than the above-described appropriate range (i.e., not less than 3.0 μm and less than 6.0 μm) is difficult to produce high-resolution and high-quality images. When such a toner is used for a developer, the average particle diameter of toner particles in the developer may vary along with repeated consumption and supplement of toner particles. When the ratio (Dv/Dn) of the volume average particle diameter (Dv) to the number average particle diameter (Dn) is too large, the similar phenomena may occur. When the ratio (Dv/Dn) is too small, the toner can be uniformly charged, but cannot be charged to a desired level or cleanability may deteriorate.

The binder resin of the toner includes the modified polyester. The modified polyester includes an ester bond and a chemical bond other than the ester bond. Such a modified polyester can be prepared from a reaction between a polyester having a functional group reactive with an active hydrogen group and a compound having an active hydrogen group, for example.

The polyester having a functional group reactive with an active hydrogen group may be, for example, a polyester having an isocyanate group or an epoxy group, which can be prepared from a reaction between a base polyester and an isocyanating agent or an epoxidation agent, respectively.

For example, when the binder resin includes a modified polyester prepared from an elongation reaction between a polyester having an isocyanate group and an amine (i.e., a compound having an active hydrogen group), the resulting toner has a wide fixable temperature range.

Specific examples of usable isocyanating agents include, but are not limited to, aliphatic polyisocyanates (e.g., tetramethylene diisocyanate, hexamethylene diisocyanate, 2,6-diisocyanatomethyl caproate); alicyclic polyisocyanates (e.g., isophorone diisocyanate, cyclohexylmethane diisocyanate); aromatic diisocyanates (e.g., tolylene diisocyanate, diphenylmethane diisocyanate); aromatic aliphatic diisocyanates (e.g., α,α,α′,α′-tetramethylxylylene diisocyanate); isocyanurates; and the above polyisocyanates blocked with a phenol derivative, an oxime, or a caprolactam. These compounds can be used alone or in combination.

Specific examples of usable epoxidation agents include, but are not limited to, epichlorohydrin.

Just as an example, a case in which a polyester having an isocyanate group (i.e., the polyester having a functional group reactive with an active hydrogen group) reacts with an amine (i.e., the compound having an active hydrogen group) to produce a urea-modified polyester is described in detail below.

When preparing the polyester having an isocyanate group, the equivalent ratio [NCO]/[OH] of isocyanate groups [NCO] in the isocyanating agent to hydroxyl groups [OH] in the base polyester is preferably from 5/1 to 1/1, more preferably from 4/1 to 1.2/1, and most preferably from 2.5/1 to 1.5/1. When [NCO]/[OH] is too large, low-temperature fixability of the resulting toner may be poor. When [NCO]/[OH] is too small, hot offset resistance of the resulting toner may be poor because the amount of urea bonds in the modified polyester is too small.

The content of the isocyanating agent in the resulting modified polyester is preferably from 0.5 to 40% by weight, more preferably from 1 to 30% by weight, and most preferably from 2 to 20% by weight. When the content is too small, hot offset resistance, heat-resistant storage stability, and low-temperature fixability of the resulting toner may be poor. When the content is too large, low-temperature fixability of the resulting toner may be poor.

The number of isocyanate groups in one molecule of the resulting modified polyester is preferably 1 or more. The average number is preferably from 1.5 to 3, more preferably from 1.8 to 2.5. When the number of isocyanate groups per molecule is too small, hot offset resistance of the resulting toner may be poor because the molecular weight of the resulting urea modified polyester is too small.

Specific examples of usable amines include, but are not limited to, diamine compounds, polyamine compounds having 3 or more valences, amino alcohol compounds, amino mercaptan compounds, amino acid compounds, and such compounds in which the amino group is blocked.

Specific examples of the diamine compounds include, but are not limited to, aromatic diamines (e.g., phenylenediamine, diethyltoluenediamine, 4,4′-diaminophenylmethane); alicyclic diamines (e.g., 4,4′-diamino-3,3′-dimethyldicyclohexylmethane, diamine cyclohexane, isophoronediamine); and aliphatic diamines (e.g., ethylenediamine, tetramethylenediamine, hexamethylenediamine).

Specific examples of the polyamine compounds having 3 or more valences include, but are not limited to, diethylenetriamine and triethylenetetramine.

Specific examples of the amino alcohol compounds include, but are not limited to, ethanolamine and hydroxyethylaniline.

Specific examples of the amino mercaptan compounds include, but are not limited to, aminoethyl mercaptan and aminopropyl mercaptan.

Specific examples of the amino acid compounds include, but are not limited to, aminopropionic acid and aminocaproic acid.

Specific examples of the above compounds in which the amino group is blocked include, but are not limited to, ketimine compounds prepared from amines and ketones (e.g., acetone, methyl ethyl ketone, methyl isobutyl ketone), and oxazoline compounds.

Among the above-described amines, diamine compounds and mixtures of a diamine compound and a small amount of a polyamine compound are preferable. The amines function as a crosslinking agent or an elongating agent.

The molecular weight of the modified polyester can be controlled by an elongation terminator. Specific preferred materials for the elongation terminator include, but are not limited to, monoamines (e.g., diethylamine, dibutylamine, butylamine, laurylamine) and ketimine compounds (i.e., blocked monoamines).

The equivalent ratio [NCO]/[NHx] of isocyanate groups [NCO] in the modified polyester and amino groups [NHx] in the amine is preferably from 1/2 to 2/1, more preferably from 1.5/1 to 1/1.5, and most preferably from 1.2/1 to 1/1.2. When [NCO]/[NHx] is too large or small, hot offset resistance of the resulting toner may be poor because the molecular weight of the resulting urea modified polyester is too small.

The modified polyester may further include urethane bonds other than urea bonds. In such a case, the molar ratio of urea bonds to urethane bonds is preferably from 100/0 to 10/90, more preferably from 80/20 to 20/80, and most preferably from 60/40 to 30/70. When the molar ratio of urea bonds is too small, hot offset resistance of the resulting toner may be poor.

The modified polyester preferably has a weight average molecular weight of 10,000 or more, more preferably from 20,000 to 10,000,000, and most preferably from 30,000 to 1,000,000. When the weight average molecular weight is too small, hot offset resistance of the resulting toner may be poor. Additionally, the modified polyester preferably has a number average molecular weight of 20,000 or less, more preferably from 1,000 to 10,000, and most preferably from 2,000 to 8,000. When the number average molecular weight is too large, low-temperature fixability of the resulting toner may be poor and the resulting images have low gloss. When the modified polyester is used in combination with the below-described unmodified polyester, the number average molecular weight of the modified polyester is not limited to any particular value.

For the sake of clarity, the modified polyester may be hereinafter referred to as the modified polyester (i).

The binder resin may optionally include an unmodified polyester (ii) in combination with the modified polyester (i). The toner including both the modified polyester (i) and the unmodified polyester (ii) has better low-temperature fixability and provides glossy images when used in a full-color image forming apparatus. From the viewpoint of low-temperature fixability and hot offset resistance, it is preferable that the modified polyester (i) and the unmodified polyester (ii) are completely or partially compatible with each other. Accordingly, it is preferable that the modified polyester (i) and the unmodified polyester (ii) have a similar chemical composition.

The unmodified polyester (ii) preferably has a peak molecular weight of from 1,000 to 30,000, more preferably from 1,500 to 10,000, and most preferably from 2,000 to 8,000. When the peak molecular weight is too small, heat-resistant storage stability of the resulting toner may be poor. When the peak molecular weight is too large, low-temperature fixability of the resulting toner may be poor. The unmodified polyester (ii) preferably has a weight average molecular weight of from 2,000 to 90,000 and a glass transition temperature (Tg) of from 40 to 80° C.

The unmodified polyester (ii) preferably has a hydroxyl value of 5 mgKOH/g or more, more preferably from 10 to 120 mgKOH/g, and most preferably from 20 to 80 mgKOH/g. When the hydroxyl value is too small, both heat-resistant storage stability and low-temperature fixability of the toner may be poor.

The unmodified polyester (ii) preferably has an acid value of from 1 to 30 mgKOH/g, and more preferably from 5 to 20 mgKOH/g, so that the resulting toner can be negatively chargeable.

When the acid value and/or the hydroxyl value are/is beyond the above-described ranges, the resulting toner may be unstable at high-temperature and high-humidity conditions or low-temperature and low-humidity conditions, producing abnormal images.

The binder resin further includes a crystalline polyester (iii).

The crystalline polyester (iii) is prepared from a reaction between alcohol components and acid components. The crystalline polyester (iii) has a certain melting point.

The alcohol components for preparing the crystalline polyester (iii) preferably include diol compounds having 2 to 6 carbon atoms, such as 1,4-butanediol, 1,6-hexanediol, and derivatives thereof. The acid components for preparing the crystalline polyester (iii) preferably include at least one of maleic acid, fumaric acid, succinic acid, and a derivative thereof. Accordingly, the crystalline polyester (iii) preferably has a repeating unit represented by the following formula (1):

—[—O—CO—CR₁═CR₂—CO—O—(CH₂)ₙ—]— (1)

wherein each of R₁ and R₂ independently represents a hydrocarbon group having 1 to 20 carbon atoms, and n represents a natural number.

The crystallinity and softening point of the crystalline polyester (iii) can be controlled by a molecularly-designed nonlinear polyester, for example. Such a nonlinear polyester can be prepared from a condensation polymerization between alcohol components including a polyol having 3 or more valences (e.g., glycerin) and acid components including a polycarboxylic acid having 3 or more valences (e.g., trimellitic anhydride).

The molecular structure of the crystalline polyester (iii) can be determined by solid NMR.

A molecular weight distribution chart, the lateral axis indicating logarithm of molecular weight (hereinafter “log(M)”) and the vertical axis indicating weight distribution (%), determined by GPC, of o-dichlorobenzene-soluble components in the crystalline polyester (iii) preferably has a peak at a log(M) of from 3.5 to 4.0. The half bandwidth of the peak is preferably 1.5 or less. According to the chart, the weight average molecular weight (Mw) is preferably from 1,000 to 6,500, the number average molecular weight (Mn) is preferably from 500 to 2,000, and the ratio (Mw/Mn) is preferably from 2 to 5. When the crystalline polyester (iii) satisfies the above-described ranges, the resulting toner has good low-temperature fixability.

A differential thermal curve measured by differential scanning calorimetry (DSC) of the crystalline polyester (iii) preferably has an endothermic peak at between 50° C. and 150° C. When the temperature is too low, toner blocking may occur in a developing device because heat-resistant storage stability of the resulting toner is poor. When the temperature is too high, low-temperature fixability of the resulting toner may be poor.

The crystalline polyester (iii) preferably dispersed in the toner with a dispersion diameter of from 0.2 to 3.0 μm. In this specification, the dispersion diameter is defined as the maximum diameter.

When the dispersion diameter of the crystalline polyester (iii) is from 0.2 to 3.0 μm, the microcrystalline wax can be more finely dispersed in the toner, preventing localization of the microcrystalline wax at the surface of the toner.

The crystalline polyester (iii) preferably has an acid value of from 8 to 45 mgKOH/g. From the viewpoint of improving low-temperature fixability of the resulting toner by increasing affinity for paper, the acid value is preferably 8 mgKOH/g or more, more preferably 20 mgKOH/g or more. From the viewpoint of improving hot offset resistance of the resulting toner, the acid value is preferably 45 mgKOH/g or less.

The crystalline polyester (iii) preferably has a hydroxyl value of from 0 to 50 mgKOH/g, more preferably from 5 to 50 mgKOH/g, so that the resulting toner has good low-temperature fixability and chargeability.

The weight ratio of the modified polyester (i) to the total of the unmodified polyester (ii) and the crystalline polyester (iii) (i.e., (i)/[(ii)+(iii)]) is preferably from 5/95 to 25/75, more preferably from 10/90 to 25/75, much more preferably from 12/88 to 25/75, and most preferably from 12/88 to 22/78. The weight ratio of the unmodified polyester (ii) to the crystalline polyester (iii) (i.e., (ii)/(iii)) is preferably from 99/1 to 50/50, more preferably from 95/5 to 60/40, and most preferably from 90/10 to 65/35. When the binder resin does not satisfy the above-described ranges, the resulting toner may have poor hot offset resistance, heat-resistant storage stability, and low-temperature fixability.

The binder resin preferably has a glass transition temperature (Tg) of from 40 to 70° C., and more preferably from 40 to 65° C. When Tg is too small, hest-resistant storage stability of the resulting toner may be poor. When Tg is too large, low-temperature fixability of the resulting toner may be poor.

In a case in which the modified polyester is a urea-modified polyester, the resulting toner has better heat-resistant storage stability than typical polyester-based toners even when Tg is relatively low.

A temperature at which the storage elastic modulus (TG′) of the binder resin becomes 10,000 dyne/cm² is preferably 100° C. or more, more preferably from 110 to 200° C., at a frequency of 20 Hz. When the temperature is too low, hot offset resistance of the resulting toner may be poor.

A temperature at which the viscosity (Tη) of the binder resin becomes 1,000 poises is preferably 180° C. or less, more preferably from 90 to 160° C., at a frequency of 20 Hz. When the temperature is too high, low-temperature fixability of the resulting toner may be poor.

Accordingly, when the temperature at which the storage elastic modulus (TG′) of the binder resin becomes 10,000 dyne/cm² is higher than the temperature at which the viscosity (Tη) of the binder resin becomes 1,000 poises, both low-temperature fixability and hot offset resistance of the resulting toner are good. Specifically, the difference between the above two temperatures is preferably from 0 to 100° C., more preferably from 10 to 90° C., and most preferably from 20 to 80° C.

A molecular weight distribution chart of THF-soluble components of the binder resin preferably has a peak at a molecular weight of from 1,000 to 30,000. According to the chart, the THF-soluble components of the binder resin preferably include components having a molecular weight of 30,000 or more in an amount of from 1 to 80% by weight, and preferably have a number average molecular weight of from 2,000 to 15,000. Further, the THF-soluble components of the binder resin preferably include components having a molecular weight of 1,000 or less in an amount of from 0.1 to 5.0% by weight. The binder resin preferably includes THF-insoluble components in an amount of from 1 to 15% by weight.

The toner according to this specification may include a colorant. Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. Two or more of such colorants can be used in combination. The content of the colorant in the toner is preferably from 1 to 15% by weight, and more preferably from 3 to 10% by weight.

The colorant can be combined with a resin to be used as a master batch. Specific examples of the resin for use in the master batch include, but are not limited to, the above-described modified or unmodified polyester, polymers of styrene or styrene derivatives (e.g., polystyrene, poly-p-chlorostyrene, polyvinyl toluene), styrene-based copolymers (e.g., styrene-p-chlorostyrene copolymer, styrene-propylene copolymer, styrene-vinyltoluene copolymer, styrene- vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene- methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer), polymethyl methacrylate, polybutyl methacrylate, polyvinyl chloride, polyvinyl acetate, polyethylene, polypropylene, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. Two or more of such resins can be used in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

The toner according to this specification may include a chare controlling agent. Specific examples of usable charge controlling agent include, but are not limited to, Nigrosine dyes, triphenylmethane dyes, metal complex dyes including chromium, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives.

Specific examples of commercially available charge controlling agents include, but are not limited to, BONTRON® N-03 (Nigrosine dyes), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® PR (triphenyl methane derivative), COPY CHARGE® NEG VP2036 and COPY CHARGES) NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, and a quaternary ammonium group.

The content of the charge controlling agent is preferably 0.1 to 10 parts by weight, more preferably from 0.2 to 5 parts by weight, based on 100 parts by weight of the binder resin. When the content of charge controlling agent is too large, the toner may be excessively charged and electrostatically attracted to a developing roller, resulting in poor fluidity of the toner and low image density.

The charge controlling agent may be directly mixed with the binder resin or the master batch, or added to the toner components liquid. Alternatively, the charge controlling agent may be fixed on the surface of the toner.

The toner according to this specification may be prepared by dissolving or dispersing toner components including the release agent and one or both of the binder resin and a precursor thereof in an organic solvent to prepare a toner components liquid; emulsifying the toner components liquid in an aqueous medium to prepare an emulsion; and removing the organic solvent from the emulsion. The aqueous medium may disperse a particulate resin which can improve dispersibility of liquid droplets of the toner components liquid to narrow the particle diameter distribution thereof.

Specific preferred resins suitable for the particulate resin include, but are not limited to, thermoplastic and thermosetting resins such as vinyl resin, polyurethane, epoxy resin, polyester, polyamide, polyimide, silicone resin, phenol resin, melamine resin, urea resin, aniline resin, ionomer resin, and polycarbonate. Two or more of these resins can be used in combination. Among these resins, vinyl resin, polyurethane, epoxy resin, polyester, and mixtures thereof are preferable because they can easily form an aqueous dispersion of fine spherical particles thereof.

The vinyl resin may be a homopolymer or a copolymer of vinyl monomers, such as styrene-(meth)acrylate resin, styrene-butadiene copolymer, (meth)acrylic acid-acrylate copolymer, styrene-acrylonitrile copolymer, styrene-maleic anhydride copolymer, and styrene-(meth)acrylic acid copolymer.

The particulate resin preferably has a volume average particle diameter of from 5 to 500 nm.

To more improve fluidity, developability, chargeability, and cleanability of the toner, an external additive may be added to the surface of the toner.

Specific preferred materials suitable for the external additive include particulate inorganic materials. The particulate inorganic materials preferably have a primary diameter of from 5 mμ to 2 μm, and more preferably from 5 to 500 mμ.

The toner preferably has a BET specific surface area of from 20 to 500 m²/g. The content of the particulate inorganic material is preferably from 0.01 to 5% by weight, more preferably from 0.01 to 2.0% by weight, based on the toner.

Specific examples of usable particulate inorganic materials include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

Additionally, particles of polymers prepared by soap-free emulsion polymerization, suspension polymerization, or dispersion polymerization (e.g., polystyrene, copolymers of methacrylates or acrylates), polycondensation polymers (e.g., silicone, benzoguanamine, nylon), and thermosetting resins are also usable as the external additive.

The external additive may be surface-treated with a hydrophobizing agent so that fluidity and chargeability of the toner may not deteriorate even under high-humidity conditions. Specific examples of usable hydrophobizing agents include, but are not limited to, silane coupling agents, silylation agents, silane coupling agents having a fluorinated alkyl group, organic titanate coupling agents, aluminum coupling agents, silicone oils, and modified silicone oils.

The toner according to this specification may further include a cleanability improving agent so that residual toner particles after image transfer are easily removable from a photoreceptor or a primary transfer medium. Specific preferred materials suitable for the cleanability improving agent include, but are not limited to, metal salts of fatty acids (e.g., zinc stearate, calcium stearate), and fine particles of polymers prepared by soap-free emulsion polymerization (e.g., polymethyl methacrylate, polystyrene). Such fine particles of polymers preferably have a narrow size distribution and a volume average particle diameter of from 0.01 to 1 μm.

As described above, the toner according to this specification may be prepared by dissolving or dispersing toner components including the release agent and one or both of the binder resin and a precursor thereof in an organic solvent to prepare a toner components liquid; emulsifying the toner components liquid in an aqueous medium to prepare an emulsion; and removing the organic solvent from the emulsion. However, a preparation method of the toner is not limited thereto.

The toner components include the binder resin and/or a precursor thereof. The binder resin includes the modified polyester having an ester bond and a chemical bond other than the ester bond. The precursor is capable of producing the modified polyester. Accordingly, the modified polyester preferably includes a compound having an active hydrogen group and a polyester having a functional group reactive with the active hydrogen group.

In a case in which the polyester having a functional group reactive with the active hydrogen group is a polyester having an isocyanate group (hereinafter “polyester prepolymer (A)”), the toner can be prepared as follows, for example.

First, a polyol (1) and a polycarboxylic acid (2) are heated to 150 to 280° C. in the presence of an esterification catalyst (e.g., tetrabutoxy titanate, dibutyltin oxide), while optionally reducing pressure, and the produced water is removed. Thus, a polyester having a hydroxyl group is prepared.

Subsequently, the polyester having a hydroxyl group reacts with a polyisocyanate (3) at 40 to 140° C. Thus, a polyester prepolymer (A) is prepared.

The polyester prepolymer (A) further reacts with an amine (B) (i.e., the compound having an active hydrogen group) at 0 to 140° C. Thus, a modified polyester (i), that is a urea-modified polyester, is obtained.

Specific examples of the polyol (1) include, but are not limited to, alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclic diols (e.g., 1,4-cyclohexanedimethanol, hydrogenated bisphenol A), bisphenols (e.g., bisphenol A, bisphenol F, bisphenol S), alkylene oxide (e.g., ethylene oxide, propylene oxide, butylene oxide) adducts of alicyclic diols, and alkylene oxide (e.g., ethylene oxide, propylene oxide, butylene oxide) adducts of bisphenols. Two or more of these polyols can be used in combination. Among these polyols, an alkylene glycol having 2 to 12 carbon atoms and an alkylene oxide adduct of a bisphenol (e.g., ethylene oxide 2 mol adduct of bisphenol A, propylene oxide 2 mol adduct of bisphenol A, propylene oxide 3 mol adduct of bisphenol A) are preferable.

Specific examples of the polyol (1) further include polyols having 3 or more valences, such as aliphatic polyols (e.g., glycerin, trimethylolethane, trimethylolpropane, pentaerythritol, sorbitol), polyphenols having 3 or more valences (e.g., phenol novolac, cresol novolac), and alkylene oxide (e.g., ethylene oxide, propylene oxide, butylene oxide) adducts of polyphenols having 3 or more valences. Two or more of these polyols can be used in combination.

Specific examples of the polycarboxylic acid (2) include, but are not limited to, alkylene dicarboxylic acids (e.g., succinic acid, adipic acid, sebacic acid), alkenylene dicarboxylic acids (e.g., maleic acid, fumaric acid), and aromatic dicarboxylic acids (e.g., terephthalic acid, isophthalic acid, naphthalenedicarboxylic acid). Two or more of these polycarboxylic acids can be used in combination. Among these polyols, alkenylene dicarboxylic acids having 4 to 20 carbon atoms and aromatic dicarboxylic acids having 8 to 20 carbon atoms are preferable.

Specific examples of the polycarboxylic acid (2) further include polycarboxylic acid having 3 or more valences, such as aromatic polycarboxylic acids having 9 to 20 carbon atoms (e.g., trimellitic acid, pyromellitic acid). Two or more of these polycarboxylic acids can be used in combination.

Additionally, anhydrides and lower alkyl esters (e.g., methyl ester, ethyl ester, isopropyl ester) of the polycarboxylic acids can also be used in place of the polycarboxylic acids.

Specific preferred materials suitable for the polyisocyanate (3) include the above-described materials suitable for the isocyanating agents.

Specific preferred materials suitable for the amine (B) include the above-described amines.

When reacting the polyester having a hydroxyl group with the polyisocyanate (3) or reacting the polyester prepolymer (A) with the amine (B), a solvent can be used, if needed.

Specific examples of usable solvents include, but are not limited to, aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran), which are inactive with the polyisocyanate (3).

The unmodified polyester (ii) can be prepared similarly to the preparation of the above-described polyester having a hydroxyl group, and can be mixed with the modified polyester (i).

The aqueous medium may be, for example, water alone or a mixture of water with a water-miscible solvent.

Specific examples of the water miscible solvents include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone).

The aqueous medium may includes a surfactant and/or a disperser such a polymeric protection colloid to be described in detail later.

In a case in which the binder resin precursor includes the polyester prepolymer (A) and the amine (B), the polyester prepolymer (A) may react with the amine (B) in the aqueous medium to prepare the modified polyester (i). Alternatively, the polyester prepolymer (A) may previously react with the amine (B) to prepare the modified polyester (i) before added to the aqueous medium.

To form a reliable dispersion of the polyester prepolymer (A) and the amine (B) or the modified polyester (i), a shearing force is preferably applied to the aqueous medium when the toner components including the polyester prepolymer (A) and the amine (B) or the modified polyester (i), the crystalline polyester (iii), and the release agent are added thereto.

The polyester prepolymer (A) and the other toner components, such as a colorant or a colorant master batch, the release agent, the crystalline polyester (iii), the unmodified polyester (ii), and a charge controlling agent, may be mixed at the time they are added to the aqueous medium. However, it is more preferable that the toner components are previously mixed with each other, and the resultant mixture is added to the aqueous medium.

The colorant and the charge controlling agent are not necessarily mixed with other toner components at the time they are added to the aqueous medium, and may be added to the resulting particles. Alternatively, the resulting particles can be dyed with a colorant.

The toner component liquid is dispersed in the aqueous medium using a low-speed shearing disperser, a high-speed shearing disperser, a frictional disperser, a high-pressure jet disperser, or an ultrasonic disperser, for example. A high-speed shearing disperser is preferable for controlling the particle diameter of the dispersing oil droplets into 2 to 20 μm. In this case, the revolution is preferably from 1,000 to 30,000 rpm, and more preferably from 5,000 to 20,000 rpm. The dispersing time is preferably from 0.1 to 5 minutes. The dispersing temperature is preferably from 0 to 150° C. (under pressure), and more preferably from 40 to 98° C. The higher dispersing temperature is more preferable because the resulting dispersion has a low viscosity.

The amount of the aqueous medium is preferably from 50 to 2,000 parts by weight, more preferably from 100 to 1,000 parts by weight, based on 100 parts by weight of the toner components. When the amount of the aqueous medium is too small, the toner components may not be finely dispersed therein, and therefore the resulting toner may not have a desired particle size. When the amount of the aqueous medium is too large, manufacturing cost may increase.

As described above, the aqueous medium may contain a disperser. The disperser narrows the size distribution of the resulting toner and stabilizes the dispersion.

In a case in which the binder resin precursor includes the polyester prepolymer (A) and the amine (B), the amine (B) may be mixed with the toner components including the polyester prepolymer (A) before they are added to the aqueous medium. Alternatively, the amine (B) may be added to the aqueous medium after the toner components including the polyester prepolymer (A) are dispersed therein. In the latter case, the resulting urea-modified polyester (i) is dominantly formed at the surface of the toner particle, generating a concentration gradient of urea bonds within the toner particle.

As described above, the aqueous medium may contain a surfactant to reliably emulsify or disperse the toner components liquid in the aqueous medium.

Specific examples of usable surfactants include, but are not limited to, anionic surfactants (e.g., alkylbenzene sulfonate, α-olefin sulfonate, phosphate), amine salt type cationic surfactants (e.g., alkylamine salts, amino alcohol fatty acid derivatives, imidazoline), quaternary ammonium salt type cationic surfactants (e.g., alkyl trimethyl ammonium salt, dialkyl dimethyl ammonium salt, alkyl dimethyl benzyl ammonium salt, pyridinium salt, alkyl isoquinolinium salt, benzethonium chloride), nonionic surfactants (e.g., fatty acid amide derivatives, polyol derivatives), and ampholytic surfactants (e.g., alanine, dodecyl di(aminoethyl) glycine, di(octyl aminoethyl) glycine, N-alkyl-N,N-dimethyl ammonium betaine).

Surfactants having a fluoroalkyl group are also usable. Specific examples of anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[w- fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid dimethanol amide, N-propyl-N-(2-hydroxyethyl) perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of commercially available such anionic surfactants having a fluoroalkyl group include, but are not limited to, SURFLON® S-111, S-112, and S-113 (from AGC Seimi Chemical Co., Ltd.); FLUORAD™ FC-93, FC-95, FC-98, and FC-129 (from Sumitomo 3M); UNIDYNE™ DS-101 and DS-102 (from Daikin Industries, Ltd.); MEGAFACE F-110, F-120, F-113, F-191, F-812, and F-833 (from DIC Corporation); EFTOP EF-102, 103, 104, 105, 112, 123A, 123B, 306A, 501, 201, and 204 (from Mitsubishi Materials Electronic Chemicals Co., Ltd.); and FTERGENT F-100 and F-150 (from Neos Company Limited).

Specific examples of cationic surfactants having a fluoroalkyl group include, but are not limited to, aliphatic primary, secondary, and tertiary amine acids having a fluoroalkyl group; and aliphatic tertiary ammonium salts such as perfluoroalkyl(C6-C10) sulfonamide propyl trimethyl ammonium salts, benzalkonium salts, benzethonium chlorides, pyridinium salts, and imidazolinium salts.

Specific examples of commercially available such cationic surfactants having a fluoroalkyl group include, but are not limited to, SURFLON® S-121 (from AGC Seimi Chemical Co., Ltd.); FLUORAD™ FC-135 (from Sumitomo 3M); UNIDYNE™ DS-202 (from Daikin Industries, Ltd.); MEGAFACE F-150 and F-824 (from DIC Corporation); EFTOP EF-132 (from Mitsubishi Materials Electronic Chemicals Co., Ltd.); and FTERGENT F-300 (from Neos Company Limited).

Inorganic compounds, such as tricalcium phosphate, calcium carbonate, titanium oxide, colloidal silica, and hydroxyapatite, are also usable as the disperser.

Additionally, polymeric protection colloids are usable so as to more stabilize the dispersing oil droplets.

Specific examples of usable polymeric protection colloids include, but are not limited to, homopolymers and copolymers obtained from monomers, such as acid monomers (e.g., acrylic acid, methacrylic acid, α-cyanoacrylic acid, α-cyanomethacrylic acid, itaconic acid, crotonic acid, fumaric acid, maleic acid, maleic anhydride), acrylate and methacrylate monomers having hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylol acrylamide, N-methylol methacrylamide), vinyl ether monomers (e.g., vinyl methyl ether, vinyl ethyl ether, vinyl propyl ether), vinyl carboxylate monomers (e.g., vinyl acetate, vinyl propionate, vinyl butyrate), amide monomers (e.g., acrylamide, methacrylamide, diacetone acrylamide) and methylol compounds thereof, acid chloride monomers (e.g., acrylic acid chloride, methacrylic acid chloride), and/or monomers containing nitrogen or a nitrogen-containing heterocyclic ring (e.g., vinyl pyridine, vinyl pyrrolidone, vinyl imidazole, ethylene imine); polyoxyethylene-based resins (e.g., polyoxyethylene, polyoxypropylene, polyoxyethylene alkyl amine, polyoxypropylene alkyl amine, polyoxyethylene alkyl amide, polyoxypropylene alkyl amide, polyoxyethylene nonyl phenyl ether, polyoxyethylene lauryl phenyl ether, polyoxyethylene stearyl phenyl ester, polyoxyethylene nonyl phenyl ester); and celluloses (e.g., methyl cellulose, hydroxyethyl cellulose, hydroxypropyl cellulose).

In a case in which an acid-soluble or alkali-soluble compound (e.g., calcium phosphate) is used as the disperser, preferably, the resulting toner particles are first washed with an acid (e.g., hydrochloric acid) or an alkali and then washed with water. Alternatively, such a disperser can be removed with an enzyme.

The disperser may remain on the surface of the resulting toner. However, it is preferable that the disperser is washed or removed after the termination of the elongation and/or crosslinking reaction, in terms of chargeability of the toner.

To further reduce the viscosity of the toner components liquid to obtain toner particles with a narrower size distribution, solvents which can dissolve the modified polyester (i) and/or the polyester prepolymer (A) are preferable. Preferably, the solvents are volatile and have a boiling point less than 100° C., because such solvents are easily removable.

Specific examples of such solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Two or more of these solvents can be used in combination. Among these solvents, aromatic solvents (e.g., toluene, xylene) and halogenated hydrocarbons (e.g., methylene chloride, 1,2-dichloroethane, chloroform, carbon tetrachloride) are preferable. The used amount of the solvent is preferably from 0 to 300 parts by weight, more preferably from 0 to 100 parts by weight, and most preferably from 25 to 70 parts by weight, based on 100 parts by weight of the polyester prepolymer (A). The solvent is removed by application of heat at normal or reduced pressures after the termination of the elongation and/or crosslinking reaction.

The elongation and/or crosslinking reaction time between the polyester prepolymer (A) and the amine (B) is preferably from 10 minutes to 40 hours, and more preferably from 2 to 24 hours. The reaction temperature is preferably from 0 to 150° C., and more preferably from 40 to 98° C. A catalyst (e.g., dibutyltin laurate, dioctyltin laurate) can be used, if needed.

The solvent can be removed from the emulsion by gradually heating the emulsion to completely evaporate the solvent from liquid droplets. Alternatively, the solvent can be removed from the emulsion by spraying the emulsion into dry atmosphere to completely evaporate the solvent from liquid droplets. In the latter case, aqueous dispersers, if any, can also be evaporated.

The dry atmosphere into which the emulsion is sprayed may be, for example, air, nitrogen gas, carbon dioxide gas, or combustion gas, which is heated to above the maximum boiling point among the solvents. Such a treatment can be reliably performed by a spray drier, a belt drier, or a rotary kiln, within a short period of time.

In a case in which the emulsion is subjected to washing and drying treatments while containing toner particles having a wide size distribution, the toner particles are preferably subjected to a classification treatment.

Specifically, the classification treatment removes undesired-size particles from the resulting particles in a liquid by a cyclone, a decanter, or a centrifugal separator. Of course, the classification treatment can be performed after drying the resulting particles, but is more effectively performed in a liquid. The collected undesired-size particles, either in dry or wet condition, can be reused for preparation of toner particles.

The disperser is preferably removed in the process of the classification treatment.

The dried toner particles are optionally mixed with fine particles of a release agent, a charge controlling agent, a fluidizer, and/or a colorant, and these fine particles can be fixedly adhered to the surfaces of the toner particles by application of mechanical impulsive force.

Mechanical impulsive force can be applied by agitating toner particles using blades rotating at a high speed, or accelerating toner particles by a high-speed airflow to collide with a collision plate.

Such a treatment can be performed by ONG MILL (from Hosokawa Micron Co., Ltd.), a modified I TYPE MILL in which the pulverizing air pressure is reduced (from Nippon Pneumatic Mfg. Co., Ltd.), HYBRIDIZATION SYSTEM (from Nara Machine Co., Ltd.), KRYPTON SYSTEM (from Kawasaki Heavy Industries, Ltd.), or an automatic mortar.

The toner according to this specification may be used for both a one-component developer and a two-component developer.

The two-component developer is prepared by mixing the toner with a magnetic carrier. The weight ratio of the toner to the carrier is preferably 1/100 to 10/100.

The magnetic carrier may be a ferrite powder, a magnetite powder, or a magnetic resin carrier, each having a particle diameter of about 20 to 200 μm.

The surface of the magnetic carrier may be covered with resins such as amino resins (e.g., urea-formaldehyde resin, melamine resin, benzoguanamine resin, urea resin, polyamide resin, epoxy resin), polyvinyl or polyvinylidene resins (e.g., acrylic resin, polymethyl methacrylate resin, polyacrylonitrile resin, polyvinyl acetate resin, polyvinyl alcohol resin, polyvinyl butyral resin), polystyrene-based resins (e.g., polystyrene resin, styrene-acrylic copolymer resin), halogenated olefin resins (e.g., polyvinyl chloride), polyester resins (e.g., polyethylene terephthalate resin, polybutylene terephthalate resin), polycarbonate resins, polyethylene resins, polyvinyl fluoride resins, polyvinylidene fluoride resins, poly(trifluoroethylene) resins, poly(hexafluoropropylene) resins, vinylidene fluoride-acrylic monomer copolymer, vinylidene fluoride-vinyl fluoride copolymer, fluoroterpolymers (e.g., tetrafluoroethylene-vinylidene fluoride-non-fluoride monomer terpolymer), and silicone resins.

The above resins may include conductive powders. Specific examples of usable conductive powders include, but are not limited to, carbon black, titanium oxide, tin oxide, and zinc oxide. The conductive powders preferably have an average diameter of 1 μm or less. When the average diameter is too small, it is difficult to control electric resistivity.

The toner according to this specification is usable as a one-component developer without using a carrier.

The image forming method according to this specification includes charging an image bearing member; developing an electrostatic latent image formed on the charged image bearing member into a toner image with the toner according to this specification; transferring the toner image from the image bearing member onto a transfer member; and fixing the toner image on the transfer member by applying heat and pressure.

FIG. 2 schematically illustrates an image forming apparatus for practicing the image forming method according to this specification.

A photoreceptor 1, serving as the image bearing member, is driven to rotate counterclockwise in FIG. 2. A surface of the photoreceptor 1 is uniformly charged by a charger 2 while rotating, and then exposed to a light beam γ containing image information emitted from an exposure device, not shown, at an exposure area provided downstream from the charger 2 relative to the direction of rotation of the photoreceptor 1. Thus, charges present on the surface of the photoreceptor 1 onto which the light beam γ is emitted disappear, resulting in formation of an electrostatic latent image on the photoreceptor 1.

A developing device 3 is provided downstream from the exposure area. The developing device 3 contains a toner 4, that is the toner according to this specification. An agitation paddle 14 equipped with a conveyance screw 13 agitates the toner 4 so that the toner 4 is frictionally charged to a predetermined potential. A developing sleeve 5 then conveys the charged toner 4 to a developing area formed between the developing sleeve 5 and the photoreceptor 1. In the developing area, the toner 4 migrates from a surface of the developing sleeve 5 toward a surface of the photoreceptor 1 due to an electric field formed by a developing bias applicator, not shown. The toner 4 finally adheres to the electrostatic latent image formed on the surface of the photoreceptor 1, resulting in formation of a toner image.

The toner image is transferred from the photoreceptor 1 onto a transfer paper S at a transfer area formed between the photoreceptor 1 and a transfer conveyance belt 6, downstream from the developing device 3. The transfer paper S is fed to the transfer area by registration rollers 18. The transfer paper S having the toner image thereon is then conveyed to a fixing device, not shown, provided downstream from the transfer area relative to the direction of rotation of the transfer conveyance belt 6. A fixing member in the fixing device fixes the toner image on the transfer paper S by application of heat and pressure. The transfer paper S onto which the toner is fixed is finally discharged to a discharge tray. The transfer conveyance belt 6 is suspended by a bias roller 6a.

Residual toner particles remaining on the photoreceptor 1 after transferring the toner image are removed and collected by a cleaning blade 7, a recovery spring 8, and a recovery coil 9. Residual charges remaining on the photoreceptor 1 after removing the residual toner particles are neutralized by a neutralizer 20 (e.g., a neutralization lamp). In FIG. 2, a numeral 16 denotes a reflected density detecting sensor (i.e. a P sensor), a numeral 17 denotes a toner density detecting sensor, and a numeral 10 denotes a process cartridge (i.e., PCU).

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Manufacture Example 1

### Preparation of Particulate Resin Emulsion

A reaction vessel equipped with a stirrer and a thermometer was charged with 700 parts of water, 12 parts of a sodium salt of a sulfate of ethylene oxide adduct of methacrylic acid (ELEMINOL RS-30 from Sanyo Chemical Industries, Ltd.), 140 parts of styrene, 140 parts of methacrylic acid, and 1.5 parts of ammonium persulfate. The mixture was agitated for 20 minutes at a revolution of 450 rpm, thus preparing a whitish emulsion. The emulsion was then heated to 75° C. and subjected to reaction for 5 hours. Thereafter, 35 parts of a 1% aqueous solution of ammonium persulfate were added thereto, and the resulting mixture was aged for 5 hours at 75° C. Thus, an aqueous dispersion of a vinyl resin (i.e., a copolymer of styrene, methacrylic acid, and a sodium salt of a sulfate of ethylene oxide adduct of methacrylic acid) was prepared. This dispersion was hereinafter called as the particulate resin dispersion 1.

Resin particles in the particulate resin dispersion 1 had a volume average particle diameter of 0.30 μm when measured by a laser diffraction particle size distribution analyzer LA-920 (from Horiba, Ltd.), and a glass transition temperature of 155° C.

### Manufacture Example 2

### Preparation of Aqueous Medium

An aqueous medium was prepared by mixing and agitating 1,000 parts of water, 85 parts of the particulate resin dispersion 1, 40 parts of a 50% aqueous solution of dodecyl diphenyl ether sodium disulfonate (MON-7 from Sanyo Chemical Industries, Ltd.), and 95 parts of ethyl acetate. Thus, an aqueous medium 1, which was whitish, was prepared.

### Manufacture Example 3

### Preparation of Polyester having Hydroxyl Group

A reaction vessel equipped with a condenser, a stirrer, and a nitrogen inlet pipe was charged with 235 parts of ethylene oxide 2 mol adduct of bisphenol A, 535 parts of propylene oxide 3 mol adduct of bisphenol A, 215 parts of terephthalic acid, 50 parts of adipic acid, and 3 parts of dibutyl tin oxide. The mixture was subjected to reaction for 10 hours at 240° C. under normal pressures, and subsequently for 6 hours under reduced pressures of from 10 to 20 mmHg. Thereafter, 45 parts of trimellitic anhydride were added thereto and the mixture was further subjected to reaction for 3 hours at 185° C. under normal pressures. Thus, a low-molecular-weight polyester 1 was prepared. The low-molecular-weight polyester 1 had a number average molecular weight of 2,800, a weight average molecular weight of 7,100, a glass transition temperature of 45° C., and an acid value of 22 mgKOH/g.

### Manufacture Example 4

### Preparation of Polyester Prepolymer

A reaction vessel equipped with a condenser, a stirrer, and a nitrogen inlet pipe was charged with 700 parts of ethylene oxide 2 mol adduct of bisphenol A, 85 parts of propylene oxide 2 mol adduct of bisphenol A, 300 parts of terephthalic acid, 25 parts of trimellitic anhydride, and 3 parts of dibutyl tin oxide. The mixture was subjected to reaction for 10 hours at 240° C. under normal pressures, and subsequently for 6 hours under reduced pressures of from 10 to 20 mmHg. Thus, an intermediate polyester 1 was prepared. The intermediate polyester 1 had a number average molecular weight of 2,500, a weight average molecular weight of 10,000, a glass transition temperature of 58° C., an acid value of 0.5 mgKOH/g, and a hydroxyl value of 52 mgKOH/g.

Next, another reaction vessel equipped with a condenser, a stirrer, and a nitrogen inlet pipe was charged with 400 parts of the intermediate polyester 1, 90 parts of isophorone diisocyanate, and 500 parts of ethyl acetate. The mixture was subjected to reaction for 6 hours at 110° C. Thus, a polyester prepolymer 1 was prepared. The polyester prepolymer 1 included free-isocyanate in an amount of 1.67% by weight.

### Manufacture Example 5

### Preparation of Crystalline Polyester

A 5-liter 4-necked flask equipped with a nitrogen inlet pipe, a dewatering tube, a stirrer, and a thermocouple was charged with 28 mol of 4-butanediol, 24 mol of fumaric acid, 1.80 mol of trimellitic anhydride, and 6.0 g of hydroquinone. The mixture was subjected to reaction for 6 hours at 150° C., subsequently for 1 hour at 200° C., and subsequently 1 hour at 8.3 KPa. Thus, a crystalline polyester 1 was prepared. The crystalline polyester 1 had a melting point (i.e., the temperature at which a peak is observed in an endothermic curve determined by differential scanning calorimetry) of 125° C., a number average molecular weight of 800, a weight average molecular weight of 3,000, an acid value of 26 mgKOH/g, a hydroxyl value of 30 mgKOH/g.

### Manufacture Example 6

### Preparation of Ketimine

A reaction vessel equipped with a stirrer and a thermometer was charged with 180 parts of isophoronediamine and 80 parts of methyl ethyl ketone. The mixture was subjected to reaction for 6 hours at 50° C. Thus, a ketimine compound 1 was prepared. The ketimine compound 1 had an amine value of 420 mgKOH/g.

### Manufacture Example 7

### Preparation of Master Batch

First, 1,300 parts of water, 550 parts of a carbon black having a DBP oil absorption of 43 ml/100 g and a pH of 9.5 (PRINTEX 35 from Degussa), and 1,300 parts of the low-molecular-weight polyester 1 were mixed using a HENSCHEL MIXER (from Mitsui Mining and Smelting Co., Ltd.). The resulting mixture was kneaded for 45 minutes at 160° C. using a double roll, the kneaded mixture was then rolled and cooled, and the rolled mixture was then pulverized into particles using a pulverizer. Thus, a master batch 1 was prepared.

### Manufacture Example 8

### Preparation of Colorant-Wax Dispersion 1

A vessel equipped with a stirrer and a thermometer was charged with 400 parts of the low-molecular-weight polyester 1, 100 parts of a microcrystalline wax having an acid value of 0.1 mgKOH/g and a melting point of 65° C. and including 80 carbon atoms and 70% by weight of a linear hydrocarbon, 20 parts of a charge controlling agent (a metal complex of salicylic acid BONTRON® E-84 from Orient Chemical Industries Co., Ltd.), and 1,000 parts of ethyl acetate. The mixture was heated to 80° C. while being agitated, kept at 80° C. for 8 hours, and then cooled to 24° C. over a period of 1 hour. Further, 480 parts of the master batch 1 and 550 parts of ethyl acetate were added to the vessel, and the mixture was agitated for 1 hour. Thus, a raw material liquid 1 was prepared.

The raw material liquid was then subjected to a dispersion treatment using a bead mill (ULTRAVISCOMILL (trademark) from Aimex Co., Ltd.). The dispersing conditions were as follows.

Liquid feeding speed: 1 kg/hour

Peripheral speed of disc: 6 m/sec

Dispersion media: zirconia beads with a diameter of 0.5 mm

Filling factor of beads: 80% by volume

Repeat number of dispersing operation: 3 times (3 passes) Further, 1,000 parts of a 65% ethyl acetate solution of the low-molecular-weight polyester 1 were added, and the mixture was subjected to the above dispersion treatment again except for changing the repeat number of dispersion operation to 1 time. Thus, a colorant-wax dispersion 1 was prepared. The colorant-wax dispersion 1 contained solid components in an amount of 53% by weight.

### Manufacture Example 9

### Preparation of Colorant-Wax Dispersion 2

The procedure in Manufacture Example 8 was repeated except for replacing the microcrystalline wax with another microcrystalline wax having an acid value of 0.1 mgKOH/g and a melting point of 65° C. and including 80 carbon atoms and 55% by weight of a linear hydrocarbon. Thus, a colorant-wax dispersion 2 was prepared.

### Manufacture Example 10

### Preparation of Colorant-Wax Dispersion 3

The procedure in Manufacture Example 8 was repeated except for replacing the microcrystalline wax with another microcrystalline wax having an acid value of 0.1 mgKOH/g and a melting point of 65° C. and including 85 carbon atoms and 70% by weight of a linear hydrocarbon. Thus, a colorant-wax dispersion 3 was prepared.

### Manufacture Example 11

### Preparation of Crystalline Polyester Dispersion

A 2-liter metallic vessel was charged with 110 g of the crystalline polyester 1 and 450 g of ethyl acetate. The crystalline polyester 1 was dissolved or dispersed in the ethyl acetate at 80° C., followed by rapid cooling in ice water. After adding 500 ml of glass beads having a diameter of 3 mm to the vessel, the mixture was agitated for 10 hours by a batch-type sand mill (from Kanpe Hapio Co., Ltd.). Thus, a crystalline polyester dispersion 1 was prepared. Polymer particles in the crystalline polyester dispersion 1 had a volume average particle diameter of 0.4 μm.

### Toner Example 1

### Emulsification

First, 700 parts of the colorant-wax dispersion 1, 120 parts of the polyester prepolymer 1, 80 parts of the crystalline polyester dispersion 1, and 5 parts of the ketimine compound 1 were contained in a vessel, and the mixture was agitated for 1 minute at a revolution of 6,000 rpm using a TK HOMOMIXER (from PRIMIX Corporation). Further, 1,300 parts of the aqueous medium 1 were added to the vessel, and the mixture was agitated for 20 minutes at a revolution of 13,000 rpm using the TK HOMOMIXER. Thus, an emulsion slurry 1 was prepared.

### Solvent Removal

The emulsion slurry 1 was contained in a vessel equipped with a stirrer and a thermometer, and subjected to solvent removal for 10 hours at 30° C., and subsequent aging for 5 hours at 45° C. Thus, a dispersion slurry 1 was prepared.

### Washing and Drying

First, 100 parts of the dispersion slurry 1 was filtered under reduced pressures, thus obtaining a wet cake (i).

The wet cake (i) was mixed with 100 parts of ion-exchange water using a TK HOMOMIXER for 10 minutes at a revolution of 12,000 rpm, followed by filtering, thus obtaining a wet cake (ii).

The wet cake (ii) was mixed with 100 parts of a 10% aqueous solution of sodium hydroxide using a TK HOMOMIXER for 30 minutes at a revolution of 12,000 rpm, followed by filtering under reduced pressures, thus obtaining a wet cake (iii).

The wet cake (iii) was mixed with 100 parts of a 10% hydrochloric acid using a TK HOMOMIXER for 10 minutes at a revolution of 12,000 rpm, followed by filtering, thus obtaining a wet cake (iv).

The wet cake (iv) was mixed with 300 parts of ion-exchange water using a TK HOMOMIXER for 10 minutes at a revolution of 12,000 rpm, followed by filtering. This operation was repeated twice, thus obtaining a wet cake (v).

The wet cake (v) was dried by a drier for 48 hours at 45° C., and filtered with a mesh having openings of 75 μm. Thus, a toner 1 was prepared.

In the toner 1, the release agent was dispersed with a dispersion diameter of 0.06 μm, and the crystalline polyester was dispersed with a dispersion diameter of 0.2 μm. The toner 1 had a volume average particle diameter (Dv) of 5 μm, and the ratio (Dv/Dn) of the volume average particle diameter (Dv) to the number average particle diameter (Dn) was 1.1.

### Toner Example 2

The procedure in Toner Example 1 was repeated except for replacing the colorant-wax dispersion 1 with the colorant-wax dispersion 2. Thus, a toner 2 was prepared.

In the toner 2, the release agent was dispersed with a dispersion diameter of 1.50 μm, and the crystalline polyester was dispersed with a dispersion diameter of 3.0 μm. The toner 2 had a volume average particle diameter (Dv) of 5 μm, and the ratio (Dv/Dn) of the volume average particle diameter (Dv) to the number average particle diameter (Dn) was 1.1.

### Comparative Toner Example 1

The procedure in Toner Example 1 was repeated except for replacing the colorant-wax dispersion 1 with the colorant-wax dispersion 3. Thus, a toner 3 was prepared.

In the toner 3, the release agent was dispersed with a dispersion diameter of 1.52 μm, and the crystalline polyester was dispersed with a dispersion diameter of 3.2 μm. The toner 3 had a volume average particle diameter (Dv) of 5 μm, and the ratio (Dv/Dn) of the volume average particle diameter (Dv) to the number average particle diameter (Dn) was 1.1.

### Comparative Toner Example 2

The procedure in Toner Example 1 was repeated except for changing the amount of the crystalline polyester dispersion 1 from 80 parts to 0 part. Thus, a toner 4 was prepared.

In the toner 4, the release agent was dispersed with a dispersion diameter of 0.06 μm. The toner 4 had a volume average particle diameter (Dv) of 5 μm, and the ratio (Dv/Dn) of the volume average particle diameter (Dv) to the number average particle diameter (Dn) was 1.1.

### Toner Example 3

The procedure in Toner Example 1 was repeated except for replacing the microcrystalline wax with another microcrystalline wax having an acid value of 20 mgKOH/g and a melting point of 65° C. and including 80 carbon atoms and 70% by weight of a linear hydrocarbon. Thus, a toner 5 was prepared.

In the toner 5, the release agent was dispersed with a dispersion diameter of 0.06 μm, and the crystalline polyester was dispersed with a dispersion diameter of 0.2 μm. The toner 5 had a volume average particle diameter (Dv) of 6 μm, and the ratio (Dv/Dn) of the volume average particle diameter (Dv) to the number average particle diameter (Dn) was 1.05.

### Toner Example 4

The procedure in Toner Example 1 was repeated except for replacing the microcrystalline wax with another microcrystalline wax having an acid value of 0.1 mgKOH/g and a melting point of 90° C. and including 80 carbon atoms and 70% by weight of a linear hydrocarbon. Thus, a toner 6 was prepared.

In the toner 6, the release agent was dispersed with a dispersion diameter of 0.06 μm, and the crystalline polyester was dispersed with a dispersion diameter of 0.4 μm. The toner 6 had a volume average particle diameter (Dv) of 3.0 μm, and the ratio (Dv/Dn) of the volume average particle diameter (Dv) to the number average particle diameter (Dn) was 1.25.

### Comparative Toner Example 3

The procedure in Toner Example 1 was repeated except for replacing the microcrystalline wax with another microcrystalline wax having an acid value of 22 mgKOH/g and a melting point of 65° C. and including 80 carbon atoms and 70% by weight of a linear hydrocarbon. Thus, a toner 7 was prepared.

In the toner 7, the release agent was dispersed with a dispersion diameter of 0.06 μm, and the crystalline polyester was dispersed with a dispersion diameter of 0.2 μm. The toner 7 had a volume average particle diameter (Dv) of 5 μm, and the ratio (Dv/Dn) of the volume average particle diameter (Dv) to the number average particle diameter (Dn) was 1.1.

### Comparative Toner Example 4

The procedure in Toner Example 1 was repeated except for replacing the microcrystalline wax with another microcrystalline wax having an acid value of 0.1 mgKOH/g and a melting point of 95° C. and including 80 carbon atoms and 70% by weight of a linear hydrocarbon. Thus, a toner 8 was prepared.

In the toner 8, the release agent was dispersed with a dispersion diameter of 0.06 μm, and the crystalline polyester was dispersed with a dispersion diameter of 0.3 μm. The toner 8 had a volume average particle diameter (Dv) of 5 μm, and the ratio (Dv/Dn) of the volume average particle diameter (Dv) to the number average particle diameter (Dn) was 1.1.

### Toner Example 5

The procedure in Toner Example 1 was repeated except for replacing the microcrystalline wax with another microcrystalline wax having an acid value of 0.1 mgKOH/g and a melting point of 65° C. and including 20 carbon atoms and 55% by weight of a linear hydrocarbon. Thus, a toner 9 was prepared.

In the toner 9, the release agent was dispersed with a dispersion diameter of 1.42 μm, and the crystalline polyester was dispersed with a dispersion diameter of 1.0 μm. The toner 9 had a volume average particle diameter (Dv) of 5 μm, and the ratio (Dv/Dn) of the volume average particle diameter (Dv) to the number average particle diameter (Dn) was 1.1.

### Toner Example 6

The procedure in Toner Example 1 was repeated except for replacing the microcrystalline wax with another microcrystalline wax having an acid value of 0.1 mgKOH/g and a melting point of 65° C. and including 20 carbon atoms and 70% by weight of a linear hydrocarbon. Thus, a toner 10 was prepared.

In the toner 10, the release agent was dispersed with a dispersion diameter of 0.08 μm, and the crystalline polyester was dispersed with a dispersion diameter of 0.2 μm. The toner 10 had a volume average particle diameter (Dv) of 5 μm, and the ratio (Dv/Dn) of the volume average particle diameter (Dv) to the number average particle diameter (Dn) was 1.1.

### Evaluation

Each 100 parts of the toners 1 to 10 prepared above were mixed with 0.7 parts of a hydrophobized silica and 0.3 parts of a hydrophobized titanium oxide using a HENSCHEL MIXER.

Thereafter, 5% of each of the toners was mixed with 95% of a copper-zinc ferrite carrier having an average particle diameter of 40 μm, the surface of which was covered with a silicone resin, to prepare two-component developers. Each of the two-component developers was set in an image forming apparatus IMAGIO NEO 450 (from Ricoh Co., Ltd.), and images were continuously produced on 45 sheets of an A4-size paper.

Thereafter, during development of blank (white) image, the image forming operation was stopped, and contaminants on the photoreceptor were transferred onto a tape. The image density of the tape having the contaminants thereon and that of a blank tape were measured using a 938 spectrodensitometer (from X-Rite). Because the contaminants on the photoreceptor were attributable to the release agent released from the toner and adhered to the carrier, the difference in image density (LID) between the tape having the contaminants and the blank tape indicated contaminating power of the toner. The greater the LID, the worse the contamination of the photoreceptor (i.e., the contamination of the background portion of an image). The degree of contaminating power of the toner was graded by LID as follows.

A: ΔID was 0 to 0.40. (Contaminating power is very low.)

B: ΔID was 0.41 to 0.70. (Contaminating power is low.)

C: ΔID was 0.71 to 1.00. (Contaminating power is high.)

D: ΔID was 1.00 or more. (Contaminating power is very high.)

The compositions and evaluation results of the above-prepared toners are shown in Tables 1 and 2.

TABLE 1

| | Release agent | | | |
|---|---|---|---|---|
| | | Amount of | | |
| | Number of | linear | Acid | Melting |
| | carbon | hydrocarbon | value | point |
| | atoms | (% by weight) | (mgKOH/g) | (° C.) |
| Example 1 | 80 | 70 | 0.1 | 65 |
| Example 2 | 80 | 55 | 0.1 | 65 |
| Comparative | 85 | 70 | 0.1 | 65 |
| Example 1 | | | | |
| Comparative | 80 | 70 | 0.1 | 65 |
| Example 2 | | | | |
| Example 3 | 80 | 70 | 20 | 65 |
| Example 4 | 80 | 70 | 0.1 | 90 |
| Comparative | 80 | 70 | 22 | 65 |
| Example 3 | | | | |
| Comparative | 80 | 70 | 0.1 | 95 |
| Example 4 | | | | |
| Example 5 | 20 | 55 | 0.1 | 65 |
| Example 6 | 20 | 70 | 0.1 | 65 |

TABLE 2

| | | | Volume | |
|---|---|---|---|---|
| | Dispersion | Dispersion | average | |
| | diameter of | diameter of | particle | |
| | release | crystalline | diameter (Dv) of | |
| | agent | polyester | toner | |
| | (μm) | (μm) | (μm) | Dv/Dn |
| Example 1 | 0.06 | 0.2 | 5 | 1.1 |
| Example 2 | 1.50 | 3.0 | 5 | 1.1 |
| Comparative | 1.52 | 3.2 | 5 | 1.1 |
| Example 1 | | | | |
| Comparative | 0.06 | — | 5 | 1.1 |
| Example 2 | | | | |
| Example 3 | 0.06 | 0.2 | 6 | 1.05 |
| Example 4 | 0.06 | 0.4 | 3 | 1.25 |
| Comparative | 0.06 | 0.2 | 5 | 1.1 |
| Example 3 | | | | |
| Comparative | 0.06 | 0.3 | 5 | 1.1 |
| Example 4 | | | | |
| Example 5 | 1.42 | 1.0 | 5 | 1.1 |
| Example 6 | 0.08 | 0.2 | 5 | 1.1 |

The above results indicate that the exemplary toners, each of which is prepared by emulsifying the toner components liquid in an aqueous medium, do not contaminate carrier particles.

Additional modifications and variations of the present invention are possible in light of the above teachings. It is therefore to be understood that within the scope of the appended claims the invention may be practiced other than as specifically described herein.

What is claimed is:

1. A toner, comprising:
a binder resin comprising:
a modified polyester having an ester bond and a chemical bond other than the ester bond; and
a crystalline polyester; and
a release agent comprising:
a microcrystalline wax comprising a hydrocarbon having 20 to 80 carbon atoms, said hydrocarbon comprising 55 to 70% by weight of a linear hydrocarbon,
said microcrystalline wax having an acid value of from 0.1 to 20 mgKOH/g and a melting point of from 65 to 90° C., the melting point being a temperature at which a local maximum endothermic peak is observed in a differential thermal curve measured by differential scanning calorimetry (DSC),
said release agent being dispersed in the toner with a dispersion diameter of from 0.06 to 1.50 μm.

2. The toner according to claim 1, prepared by a method comprising:
dissolving or dispersing toner components in an organic solvent to prepare a toner components liquid, said toner components including the release agent and one or both of the binder resin and a precursor thereof;
emulsifying the toner components liquid in an aqueous medium to prepare an emulsion; and
removing the organic solvent from the emulsion.

3. The toner according to claim 2, wherein the precursor comprises:
a compound having an active hydrogen group; and
a polyester having a functional group reactive with the active hydrogen group.

4. The toner according to claim 1, wherein the toner includes the release agent in an amount of from 1 to 20% by weight based on total weight of the toner.

5. The toner according to claim 1, wherein the chemical bond is a urea bond.

6. The toner according to claim 1, wherein the crystalline polyester is dispersed in the toner with a dispersion diameter of from 0.2 to 3.0 μm.

7. The toner according to claim 1, wherein a differential thermal curve measured by differential scanning calorimetry (DSC) of the crystalline polyester has an endothermic peak at between 50° C. and 150° C.

8. The toner according to claim 1, wherein the crystalline polyester is prepared from a reaction between alcohol components and acid components,
the alcohol components including a diol compound having 2 to 6 carbon atoms, and
the acid components including at least one of maleic acid, fumaric acid, succinic acid, and a derivative thereof.

9. The toner according to claim 8, wherein the alcohol components include at least one of 1,4-butanediol, 1,6-hexanediol, and a derivative thereof.

10. The toner according to claim 1, wherein the toner has a volume average particle diameter (Dv) of not less than 3.0 μm and less than 6.0 μm.

11. The toner according to claim 1, wherein a ratio (Dv/Dn) of a volume average particle diameter (Dv) to a number average particle diameter (Dn) of the toner is from 1.05 to 1.25.

12. A one-component developer, comprising the toner according to claim 1.

13. A two-component developer, comprising the toner according to claim 1 and a carrier.

14. A developer container, comprising:
a container; and
the toner according to claim 1.

15. A method of manufacturing the toner according to claim 1, comprising:
dissolving or dispersing toner components in an organic solvent to prepare a toner components liquid, said toner components including the release agent and one or both of the binder resin and a precursor thereof;
emulsifying the toner components liquid in an aqueous medium to prepare an emulsion; and
removing the organic solvent from the emulsion.

16. An image forming method, comprising:
charging an image bearing member;
developing an electrostatic latent image formed on the charged image bearing member into a toner image with the toner according to claim 1;
transferring the toner image from the image bearing member onto a transfer member; and
fixing the toner image on the transfer member by applying heat and pressure.
